(19) United States
(12) Patent Application Publication
(10) Pub. No.: US 2016/0042034 A1
(43) Pub. Date: Feb. 11, 2016

(54) GROUPING AND PRICING LOW-COMPETITION CONTENT ITEM REQUESTS

(71) Applicant: Google Inc., Mountain View, CA (US)

(72) Inventors: David W. Sculley, II, Pittsburgh, PA (US); Daniel Golovin, Pittsburgh, PA (US)

(21) Appl. No.: 14/455,677

(22) Filed: Aug. 8, 2014

(51) Int. Cl. G06F 17/30

(52) U.S. Cl. CPC G06F 17/30469; G06F 17/3053; G06F 17/30864

(57) ABSTRACT

Methods, systems, and apparatus include computer programs encoded on a computer-readable storage medium, including a method for providing content. A set of k requests is identified, each request being associated with a request for content. Candidate content items are identified for one or more of the requests in the set. Identified candidate content items are ranked based at least in part on their respective associated bids, expected value or long-term value. Top K candidate content items are determined based on the ranking. A price is assigned to each of the top K candidate content items based on the ranking and the associated bids. One or more of the top K candidate content items are provided responsive to the requests in the set.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results. Content in these examples can be of various formats, while the devices that consume (e.g., present) the content can be equally varied in terms of their type and capabilities.

Content slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or a likelihood that the user will interact with the content presented.

### SUMMARY

In general, one innovative aspect of the subject matter described in this specification can be implemented in methods that include a computer-implemented method for providing content. The method includes identifying a set of k requests, each request being associated with a request for content. The method further includes identifying candidate content items for each of the requests in the set. The method further includes ranking all of the identified candidate content items based at least in part on their respective associated bids, expected value or long-term value. The method further includes determining top K candidate content items based on the ranking. The method further includes assigning a price to each of the top K candidate content items based on the ranking and the associated bids. The method further includes providing, responsive to the requests in the set, one or more of the top K candidate content items.

These and other implementations can each optionally include one or more of the following features. Identifying a set of k requests can include receiving a plurality of requests in a time period including accumulating requests in the set for a predetermined amount of time or until a predetermined event occurs, and thereafter closing the set, the method further comprising identifying candidate content items for the closed set. The method can further include classifying the received plurality of requests and grouping requests, based on the classifying, into sets. Grouping can further include only grouping requests in each set that have a common classification. The method can further include identifying plural sets of k requests based on the classification and conducting an auction for each set in the plural set to identify respective top K candidate content items. Determining top K candidate items can include conducting a generalized second-price (GSP) auction. The number K can be predetermined. The number can be variable and can depend on one or more of, for example, a threshold bid for candidates in the set, or expected value or long-term value based on candidates in the set. The requests in the set can be in, for example, a same search partition. The requests in the set can be in a same group defined by one or more of a vertical, a location, or a category. The request can be a request associated with a search results page or a request from a web page.

In general, another innovative aspect of the subject matter described in this specification can be implemented in computer program products that include a computer program product tangibly embodied in a computer-readable storage device and comprising instructions. The instructions, when executed by one or more processors, cause the processor to: identify a set of k requests, each request being associated with a request for content; identify candidate content items for each of the requests in the set; rank all of the identified candidate content items based at least in part on their respective associated bids, expected value or long-term value; determine top K candidate content items based on the ranking; assign a price to each of the top K candidate content items based on the ranking and the associated bids; and provide, responsive to the requests in the set, the top K candidate content items.

These and other implementations can each optionally include one or more of the following features. Identifying a set of k requests can include receiving a plurality of requests in a time period including accumulating requests in the set for a predetermined amount of time or until a predetermined event occurs, and thereafter closing the set, the instructions further including instructions for identifying candidate content items for the closed set. The instructions can further include instructions for classifying the received plurality of requests and grouping requests, based on the classifying, into subsets. Grouping can further include only grouping requests in each subset that have a common classification. The instructions can further include instructions for identifying plural sets of k requests based on the classification and conducting an auction for each set in the plural subsets to identify respective top K candidate content items.

In general, another innovative aspect of the subject matter described in this specification can be implemented in systems, including a system comprising one or more processors and one or more memory elements including instructions. The instructions, when executed, cause the one or more processors to: identify a set of k requests, each request being associated with a request for content; identify candidate content items for each of the requests in the set; rank all of the identified candidate content items based at least in part on their respective associated bids, expected value or long-term value; determine top K candidate content items based on the ranking; assign a price to each of the top K candidate content items based on the ranking and the associated bids; and provide, responsive to the requests in the set, the top K candidate content items.

These and other implementations can each optionally include one or more of the following features. Identifying a set of k requests can include receiving a plurality of requests in a time period including accumulating requests in the set for a predetermined amount of time or until a predetermined event occurs, and thereafter closing the set, the instructions further comprising instructions for identifying candidate content items for the closed set. The instructions can further include instructions for classifying the received plurality of requests and grouping requests, based on the classifying, into subsets. Grouping can further include only grouping requests in each subset that have a common classification.

Particular implementations may realize none, one or more of the following advantages. Content items associated with low-competition auctions can be priced more optimally, e.g., by grouping similar requests, determining and ranking associated candidate content items, and pricing the top-ranked candidate content items. Content providers can specify to provide a pre-determined number of impressions of content items responsive to requests for content that would otherwise have little or no competition in auctions.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content.

FIG. 2 shows a system for grouping requests and pricing associated content items.

FIG. 3 is a flowchart of an example process for grouping requests and pricing associated content items.

FIG. 4 is a block diagram of an example computer system that can be used to implement the methods, systems and processes described in this disclosure.

Like reference numbers and designations in the various drawings indicate like elements.

### DETAILED DESCRIPTION

Systems, methods, and computer program products are described for grouping requests into sets and pricing associated content items that are delivered responsive to the requests. Example request types that can be grouped into sets include requests associated with a query, requests associated with search results, or requests associated with a webpage or other publication source. Requests for which little or no competition exists in an auction for providing a content item (e.g., an advertisement) can be grouped. For example, requests associated with requests for content that are received (e.g., by a content management system) can be classified and grouped into sets. The classifications, for example, can allow the requests to be grouped by one or more of a same search partition, a vertical, a location, and/or a category. A corresponding set of candidate content items can be identified and ranked for each set of requests, rather than locating and serving candidate content items for individual ones of the requests in the set. One or more (or each) of the top-ranked candidate content items can be priced and provided responsive to all or a predetermined portion of the requests in the set.

For situations in which the systems discussed here collect and/or use information including personal information about users, the users may be provided with an opportunity to enable/disable or control programs or features that may collect and/or use personal information (e.g., information about a user's social network, social actions or activities, a user's preferences or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

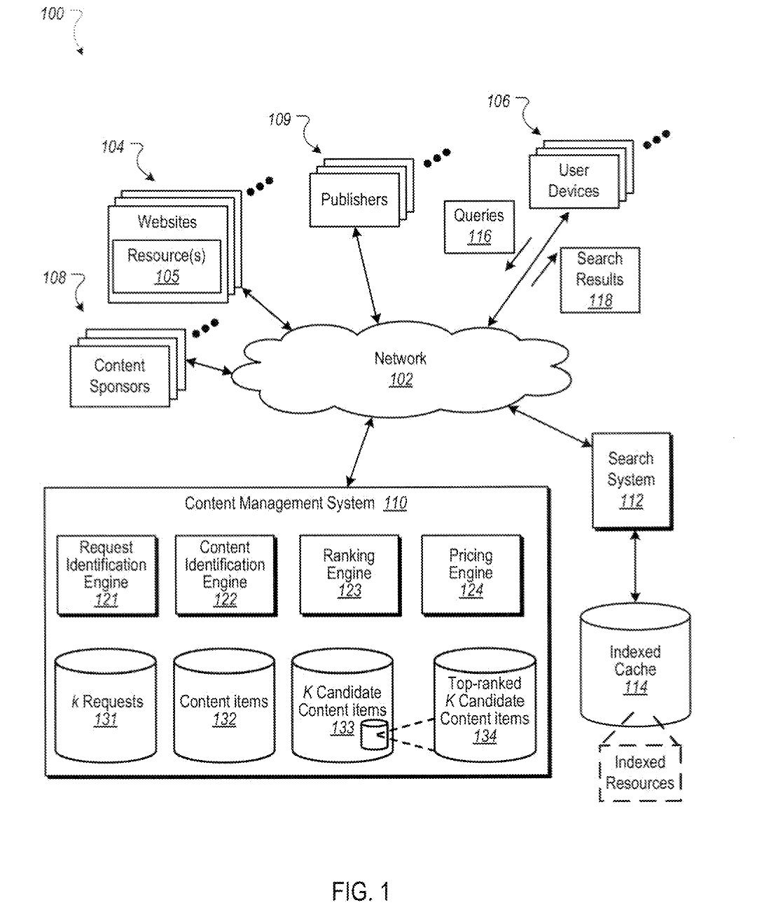

FIG. 1 is a block diagram of an example environment 100 for providing content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

The environment 100 can include plural data stores, which can be stored locally by the content management system 110, stored somewhere else and accessible using the network 102, generated as needed from various data sources, or some combination of these. Further, some data stores described herein may include identifiers that can be used to match or access corresponding data records or other information that are stored elsewhere, e.g. locally and/or remotely.

A data store of k requests 131, for example, can include a set of requests that have been grouped, e.g., by one or more of a vertical, a location, or a category. The requests, for example, can be requests that are associated with received requests for content, such as from browsers of plural users. In some implementations, a separate data store of k requests 131 can be provided for a given set of grouped requests. Requests can be purged, for example, from the data store of k requests 131 when the corresponding content items 212 are provided.

A data store of content items 132, for example, can include content items (e.g., advertisements) that can be selected in response to a received request for content. The data store of content items 132 can include, for example, an inventory of content items (e.g., creatives) provided by content sponsors 108 for presentation to users. For example, as described above, content items may be deemed to be eligible content items for a particular request for content, at least in part, by matching keywords and/or other selection information.

A data store of K candidate content items 133, for example, can include eligible content items that the content management system 110 has identified as being responsive to a set of k requests 131. For example, the K candidate content items 133 associated with a given request for content can include content items 132 that match keywords for the associated request(s) for content and/or other signals (e.g., user information, location, etc.) or match targeting criteria associated with a set of requests.

A data store of top-ranked K candidate content items 134, for example, can include the top-ranked ones of the K candidate content items 133. For example, the ranking can be based on respective bids of the K candidate content items 133 and/or other factors, e.g., including expected value, long-term value, quality scores derived from content performance, landing page scores, or other factors.

The content management system 110 can include plural engines, some or all of which may be combined or separate, and may be co-located or distributed (e.g., connected over the network 102). A request identification engine 121, for example, can receive a current request for content (i.e., associated with a current request) and identify a set of k requests 131 associated with the current request. Depending on the set identified, one or more top-ranked K content items can be identified for presentation. Content selection is discussed in greater detail below.

A content identification engine 122, for example, can identify candidate content items from the inventory of content items 132 that are responsive to a received request for content (e.g., including a then-current request). Content identification engine 122 can use the set of requests identified by the request identification engine 121 associated with the received request and can identify K candidate content items 134, at least in part, by matching keywords or other information.

A ranking engine 123, for example, can rank candidate content items within a set of K candidate content items 133. The ranking, for example, can be based at least in part on the candidate content items' respective associated bids, expected value or long-term value, and/or other factors (e.g., quality scores derived from content performance, landing page score, or other factors). The ranking engine 123 can also determine the top-ranked K candidate content items 134 based on the ranking.

A pricing engine 124, for example, can assign a price to each of the top-ranked K candidate content items 134 based on the ranking and the associated bids. For example, for each of the bids associated with the K candidate content items 133, the pricing engine 124 can assign a second price consistent with a generalized second-price (GSP) auction. Other ways can be used to price the top-ranked K candidate content items 134.

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, gaming consoles, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. Search results pages can also include one or more slots in which other content items (e.g., advertisements) can be presented.

When a resource 105, search results 118 and/or other content (e.g., a video) are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In addition, when no search is performed or no keywords are available (e.g., because the user is not browsing a webpage), other information, such as information obtained from one or more snapshots, can be used to respond to the received request. In some implementations, the selection of the eligible content items can further depend on user signals, such as demographic signals, behavioral signals or other signals derived from a user profile.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation of (or selection of or other interaction with) their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as endorsing, republishing or sharing the content item. Other actions that constitute a conversion can also be used.

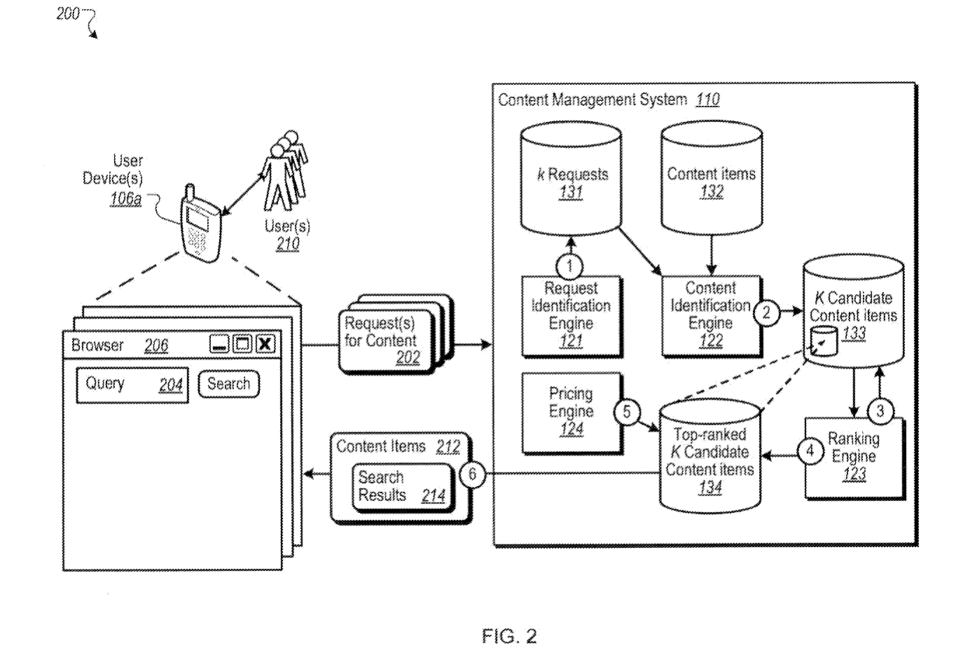

FIG. 2 shows an example system 200, for grouping requests and pricing associated content items. For example, requests associated with requests for content 202 received by the content management system 110 can be grouped into sets. Each set of requests can, for example, include requests that are in a same search partition (e.g., search engine partition), e.g., including grouping by a vertical, a location, and/or a category. For each set of k requests, for example, the content management system 110 can identify K candidate content items (e.g., a group of content items) to serve in response to receipt of a given one of the requests in the set. Each of the K candidate content items can be ranked to produce a group of top-ranked K candidate content items. One or more of (e.g., winning ones) the content item in the group of top-ranked K candidate content items can be priced. One or more of the top-ranked content items 212 can be provided responsive to the requests for content 202 along with other content, e.g., including search results 214 that are responsive to the respective requests. In some implementations, the following example stages can be used for grouping requests and pricing associated content items.

At stage 1, for example, the request identification engine 121 can identify a set of k requests 131, e.g., each request being associated with a request for content 202. For example, each request for content 202 can be a query 204 for search results sent from a browser 206 executing on the user device 106a, e.g., used by a user 208. Other types of requests for content 202 are possible. For example, request types that can be grouped into sets include requests associated with delivery of a search results page or requests from a web page.

At stage 2, for example, the content identification engine 122 can identify K candidate content items 133 for the k requests in the set. For example, K can have the same value of k, or K can have a different value. The K candidate content items can be identified, for example, from the inventory of content items 132 that are responsive to individual ones or all of the requests for content 202. For example, the K candidate content items 133 can be identified, at least in part, by matching keywords or other information in a respective request for content 202, as described above with reference to FIG. 1.

In some implementations, when a sufficient number of candidate content items are identified for a particular request (e.g., so that a subsequent auction would have sufficient competitors so as to provide effective pricing), a corresponding auction can be run as described above with reference to FIG. 1 for the particular request. When this occurs, for example, the auction can be specific to the candidate content items identified for the particular request, and the request can be omitted from the set of k requests 131. Further, in some implementations, the identified candidate content items can be omitted from the corresponding K candidate content items 133, when their inclusion was based solely on relevance to the particular request.

At stage 3, for example, the ranking engine 123 can rank all of the identified K candidate content items 133 (i.e., excluding any that have been omitted as discussed above) based at least in part on one or more criteria including their respective associated bids, expected value or long-term value. For example, the ranking engine 123 can rank the K candidate content items 133 based on their bids and/or other factors (e.g., quality scores derived from content performance, landing page score, or other factors). At this stage, ranking is performed to identify the top-ranked candidate content items for the set of requests, rather than conducting individual auctions for each individual request in the set.

At stage 4, for example, the ranking engine 123 can determine the top-ranked K candidate content items 134 based on the ranking. For example, the ranking engine 123 can identify a subset of the K candidate content items 133 that have the highest ranking, e.g., to produce the set of top-ranked K candidate content items 134 for the set.

At stage 5, for example, the pricing engine 124 can assign a price to one or more of the top-ranked K candidate content items 134 based on the ranking and the associated bids. For example, for a respective bid associated with the K candidate content items 133, the pricing engine 124 can assign a second price consistent with a generalized second-price (GSP) auction. Other ways can be used to price the top-ranked K candidate content items 134. In some implementations, only winning bids are priced.

At stage 6, for example, the content management system 110 can provide one or more of the top K candidate content items, responsive to the set of requests. In some implementations, a single content item is provided responsive to a received request. In some implementations, more than one content item is provided per request. In some implementations, the same content item is provided in response to each request in a given set. In some implementations, different ones of the top-ranked K candidate content items 134 are provided responsive to each request in the set. In some implementations, a subset of the top-ranked candidate ads are used to respond to the received requests in the set, such as distributing equally across the set a predetermined number of the top-ranked K content items. The content management system 110 can provide the content items 212, including search results 214 that are responsive to the requests for content 202.

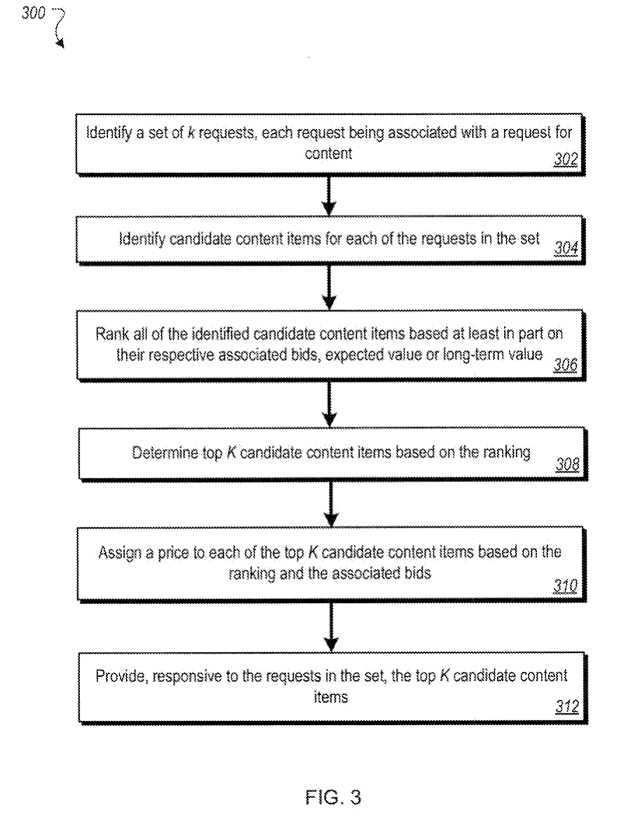

FIG. 3 is a flowchart of an example process 300 for grouping requests and pricing associated content items. In some implementations, the content management system 110 can perform steps of the process 300 using instructions that are executed by one or more processors. FIGS. 1-2 are used to provide example structures for performing the steps of the process 300.

A set of k requests is identified, each request being associated with a request for content (302). Example request types that can be grouped into sets include a request from a search results page or a request from a web page. Further, requests from a same source (e.g., search results page requests) can be further grouped based on a classification, such as by subject matter. The request identification engine 121, for example, can identify a set of k requests 131, e.g., each request being associated with a request for content 202. In some implementations, each request for content 202 can be a query 204 for search results sent from a browser 206 executing on the user device 106a.

Candidate content items are identified for each of the requests in the set (304). The content identification engine 122, for example, can identify K candidate content items 133 for each of the k requests in the set. K can have the same value of k, or K can have a different value. The K candidate content items can be identified, for example, from the inventory of content items 132 that are responsive to the request for content 202, e.g., by matching keywords or other information in the request for content 202.

In some implementations, identifying the set of k requests can include receiving a plurality of requests in a time period including accumulating requests in the set for a predetermined amount of time or until a predetermined event occurs, and thereafter closing the set, and the process 300 can further include identifying candidate content items for the closed set. For example, the content management system 110 can accumulate requests that are received within a one-second interval or some other interval that accumulates similar requests but does not contribute to significant latency. In another example, the accumulating can continue until a threshold number of requests have been received. Once the set of k requests 131 related to one set of requests is closed, for example, stages 2-6 can be executed for the set, including identifying K candidate content items 133 for the set.

In some implementations, the requests in the set can be in a same search partition. For example, the request identification engine 121 can group the k requests 131 by requests that are in the same search partition (e.g., search engine partition or “shard”).

In some implementations, the requests in the set can be in a same group defined by one or more of a vertical, a location, or a category. For example, each set of k requests 131 can be associated with one or more of a common product, a common industry, a common geographic location or geographic area for the users associated with the requests, a common device type (e.g., mobile versus non-mobile), and/or other categories that can be used to group common requests.

In some implementations, the process 300 can further include classifying the received plurality of requests and grouping requests, based on the classifying, into sets. For example, the request identification engine 121 can group requests into a set that is classified by including requests for product X received from mobile devices in or around geographic location Y.

In some implementations, grouping can further include only grouping requests in each set that have a common classification. For example, no other requests would be included in the product X/mobile/location Y set.

In some implementations, the process 300 can further include identifying plural sets of k requests based on the classification and conducting a single auction for each set in the plural sets to identify respective top K candidate content items. For example, each classified set of related requests can have associated with it a separate set of k requests 131, and the content identification engine 122 can create a separate corresponding set of K candidate content items 133.

Identified candidate content items for a given set are ranked (e.g., based at least in part on their respective associated bids, expected value or long-term value) (306). The ranking engine 123, for example, can rank all of the identified K candidate content items 133 based at least in part on their respective associated bids, expected value or long-term value. For example, the ranking engine 123 can rank the K candidate content items 133 based on their bids and/or other factors (e.g., quality scores derived from content performance, landing page score, or other factors).

Top K candidate content items are determined based on the ranking (308). The ranking engine 123, for example, can determine the top-ranked K candidate content items 134 based on the ranking. For example, the ranking engine 123 can identify a subset of the K candidate content items 133 that have the highest ranking, e.g., to produce the set of top-ranked K candidate content items 134.

In some implementations, determining top K candidate content items can include conducting a generalized second-price (GSP) auction. For example, the one or more top K candidate content items 134 can be chosen using second-place bids. The highest-bid top-ranked content item can be chosen (and priced) based on the second-highest bid, and the second-highest content item can be chosen (and priced) based on the third-highest bid, and soon.

In some implementations, the number K can be predetermined. For example, the content management system 110 can determine that, for any given set of k requests 131, the number K should be a certain value (e.g., less than k but more than one) or a proportion of k. In some implementations, machine learning techniques can be used (e.g., based on a type of vertical, a time-of-day, a country/location) to determine K. For example, K can be based on a percentage threshold for a content sponsor (e.g., “I only want to show ads 30% of the time”), a percentage of requests, a total number of content items (e.g., advertisements) over a period of time, content items in the top slots N % of the time based on position on the page, or M % for another position on the page.

In some implementations, the number K can be variable and can depend on one or more of a threshold bid for candidates in the set, or expected value or long-term value based on candidates in the set. The content management system 110, for example, can designate that K can vary, e.g., based on specific bid amounts, such as to limit the number of K candidate content items 133 to those content items having a bid above N cents (and not based on a constant K). In another example, the candidate content items can be limited to content items that are likely to have a long-term value exceeding a value threshold V.

A price is assigned to one or more (e.g., each) of the top K candidate content items based on the ranking and the associated bids (310). The pricing engine 124, for example, can assign a price to each of the top-ranked K candidate content items 134 based on the ranking and the associated bids. For each of the bids associated with the K candidate content items 133, for example, the pricing engine 124 can assign a second price consistent with a generalized second-price (GSP) auction. Other ways can be used to price the top-ranked K candidate content items 134.

One or more of the top K candidate content items are provided responsive to the requests in the set (312). The content management system 110, for example, can provide one or more the top K candidate content items, responsive to the requests in the set. In implementations involving search requests, the content management system 110 can provide the content items 212, along with search results 214 that are responsive to the request for content 202. In some implementations, a first one of the top candidate content items can be provided to a first request, and a second one of the top-ranked candidate content items can be provided to a second request associated with a given set. In some implementations, a top-ranked candidate content item is provided responsive to each request (in accordance with one or more frequency capping, budget or other constraints in an associated campaign for the top-ranked candidate content item). In some implementations, more than one candidate content item is provided in response to each request. In some implementations, when a number of requests in a set exceeds a number of top-ranked candidate content items, then one or more of the top-ranked candidate content items can be provided for plural requests in the set. These and other options for serving specific top-ranked candidate content items based on a set of requests is possible.

In some implementations, several auctions can be aggregated to run simultaneously. For example, suppose, users U₁, U₂, . . . , Uₙ issue requests Q₁, Q₂, . . . Qₙ in the same group, near-simultaneously. Let Sᵢ be the set of content items eligible for Qᵢ for i=1, 2, . . . n. Let Sₜₒₜₐₗ be the union of S₁, . . . , Sₙ. Each content item A in Sᵢ can be scored according to its expected long-term performance for Qᵢ. Let score(A) be its score. The content items in S_{tow} can be sorted, for example, by score, and the top K can be shown for some threshold K.

Using this approach, for example, can result in users receiving more or fewer content items, and some receiving none at all (e.g., user U₁ receiving 3 content items, U₂ receiving one content item, and U₃ receiving none). The content items can be priced using, for example, a GSP auction. For example, when content item A is shown to user Uᵢ, the content item A′ can be identified that has the largest score less than A, and the price to charge for A can be set to be the minimum bid possible that would result in score(A) still exceeding score(A′). Note that A′ does not need to be eligible to be shown to Uᵢ.

In some implementations it may not be infeasible to wait a long time to show the content to a specific user, e.g., a user cannot be expected to wait for other users to issue requests in the same group. A number of alternatives are possible to avoid this difficulty.

For example, one change can include simply tracking content items in each group (with their scores recorded), and for each user Uᵢ, running the auction as described above. For example, the content items with the K best scores can be selected, showing only those in Sᵢ that are in the top K content items, and pricing them according to the group level auction. Hence, if content items in Sᵢ were ranked 5th, 10th, and 12th, for example, and K=10, then the user can be shown the better two content items, e.g., in Sᵢ, in positions #1 and #2, and the content items can be priced as if they were competing against all the content items in the group (including ones that have showed before).

In another example variant, K can be removed, simply setting a dynamically changing threshold on the score that the content items need to exceed to be shown (e.g., using the threshold to set reserve prices), such that the amount of content items shown is about the same as the previous (K best-scores) case.

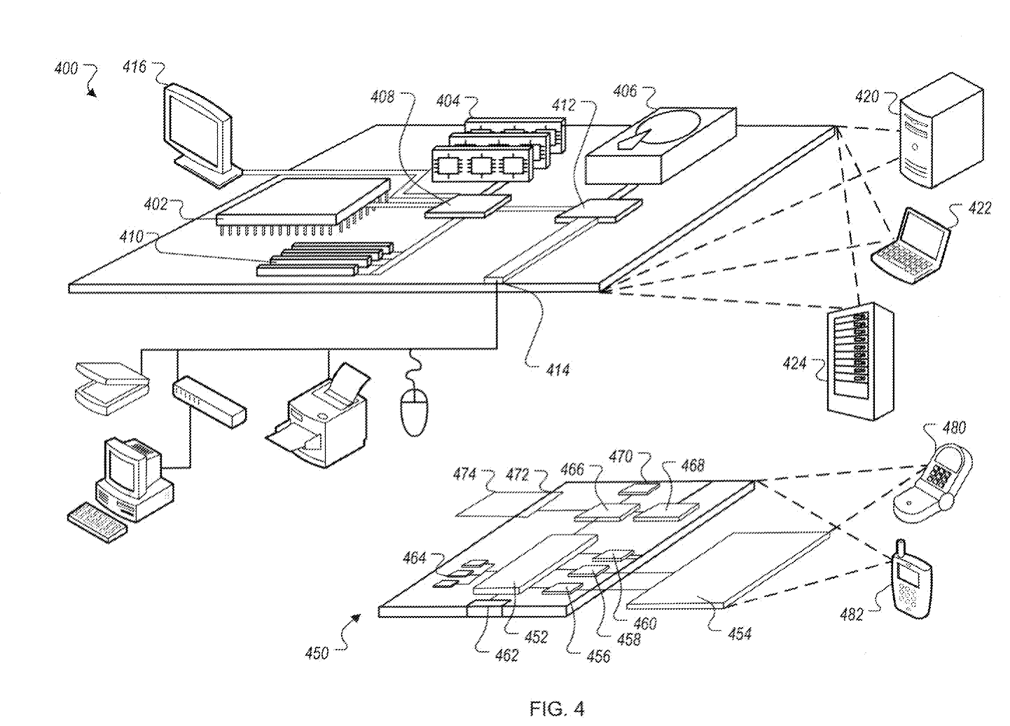

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processors embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying a set of k requests, each request being associated with a request for content;
identifying candidate content items for one or more of the requests in the set;
ranking all of the identified candidate content items based at least in part on their respective associated bids, expected value or long-term value;
determining top K candidate content items based on the ranking;
assigning a price to each of the top K candidate content items based on the ranking and the associated bids; and
providing, responsive to the requests in the set, one or more of the top K candidate content items responsive to each of the requests in the set of k requests.

2. The method of claim 1 wherein identifying a set of k requests includes receiving a plurality of requests in a time period including accumulating requests in the set for a predetermined amount of time or until a predetermined event occurs, and thereafter closing the set, the method further comprising identifying candidate content items for the closed set.

3. The method of claim 2 further comprising classifying the received plurality of requests and grouping requests, based on the classifying, into separate sets.

4. The method of claim 3 wherein grouping further includes only grouping requests in each set that have a common classification.

5. The method of claim 4 further comprising identifying plural sets of k requests based on the classification and conducting an auction for each separate set in the plural sets to identify respective top K candidate content items.

6. The method of claim 1 wherein determining top K candidate items includes conducting a generalized second-price (GSP) auction.

7. The method of claim 1 wherein a number K is predetermined.

8. The method of claim 7 wherein the number is variable and depends on one or more of a threshold bid for candidates in the set, or expected value or long-term value based on candidates in the set.

9. The method of claim 1 wherein the requests in the set are in a same search partition.

10. The method of claim 9 wherein the requests in the set are in a same group defined by one or more of a vertical, a location, or a category.

11. The method of claim 1 wherein a given request is a request from a search results page or a request from a web page.

12. A computer program product embodied in a non-transitive computer-readable medium including instructions, that when executed, cause one or more processors to:
identify a set of k requests, each request being associated with a request for content;
identify candidate content items for one or more of the requests in the set;
rank all of the identified candidate content items based at least in part on their respective associated bids, expected value or long-term value;
determine top K candidate content items based on the ranking;
assign a price to each of the top K candidate content items based on the ranking and the associated bids; and
provide, responsive to the requests in the set, one or more of the top K candidate content items.

13. The computer program product of claim 12 wherein identifying a set of k requests includes receiving a plurality of requests in a time period including accumulating requests in the set for a predetermined amount of time or until a predetermined event occurs, and thereafter closing the set, the instructions further including instructions for identifying candidate content items for the closed set.

14. The computer program product of claim 13 further comprising instructions for classifying the received plurality of requests and grouping requests, based on the classifying, into sets.

15. The computer program product of claim 14 wherein grouping further includes only grouping requests in each set that have a common classification.

16. The computer program product of claim 15, the instructions further including instructions for identifying plural sets of k requests based on the classification and conducting an auction for each set in the plural set to identify respective top K candidate content items.

17. A system comprising:
one or more processors; and
one or more memory elements including instructions that, when executed, cause the one or more processors to:
identify a set of k requests, each request being associated with a request for content;
identify candidate content items for one or more of the requests in the set;
rank all of the identified candidate content items based at least in part on their respective associated bids, expected value or long-term value;
determine top K candidate content items based on the ranking;
assign a price to each of the top K candidate content items based on the ranking and the associated bids; and
provide, responsive to the requests in the set, one or more of the top K candidate content items.

18. The system of claim 17 wherein identifying a set of k requests includes receiving a plurality of requests in a time period including accumulating requests in the set for a predetermined amount of time or until a predetermined event occurs, and thereafter closing the set, the instructions further including instructions for identifying candidate content items for the closed set.

19. The system of claim 18 further comprising instructions for classifying the received plurality of requests and grouping requests, based on the classifying, into sets.

20. The system of claim 19 wherein grouping further includes only grouping requests in each set that have a common classification.
